(19) United States
(12) Patent Application Publication
(10) Pub. No.: US 2024/0202583 A1
(43) Pub. Date: Jun. 20, 2024

(54) LONG SEQUENCE MODELING VIA STATE SPACE MODEL (SSM)-ENHANCED TRANSFORMER

(71) Applicant: Microsoft Technology Licensing, LLC, Redmond, WA (US)

(72) Inventors: Xiaodong LIU, Redmond, WA (US); Jian JIAO, Bellevue, WA (US); Simiao ZUO, Atlanta, GA (US); Jianfeng GAO, Woodinville, WA (US)

(73) Assignee: Microsoft Technology Licensing, LLC, Redmond, WA (US)

(21) Appl. No.: 18/124,536

(22) Filed: Mar. 21, 2023

Related U.S. Application Data
(60) Provisional application No. 63/387,500, filed on Dec. 14, 2022.

(51) Int. Cl. G06N 20/00

(52) U.S. Cl. CPC G06N 20/00

(57) ABSTRACT

A computing device is provided including a processor configured to execute a transformer including an encoder having a global layer configured to receive tokenized embeddings for each of a plurality of tokens in a local input sequence and compute a global self-attention vector for each of the tokenized embeddings. The encoder further includes a local layer configured to receive each global self-attention vector from the global layer and compute local self-attention for each local input sequence, and add and normalize the global self-attention vector with the local self-attention vector to thereby produce an encoder representation including a self-attention vector for each local input sequence that includes both global self-attention values and local self-attention values. The transformer is configured to output a prediction for the global input sequence based on the encoder representation of each of the local input sequences of the global input sequence.

### CROSS REFERENCE TO RELATED APPLICATIONS

The present application is based upon and claims priority under 35 U.S.C. 119(e) to U.S. Provisional Patent Application No. 63/387,500, entitled LONG SEQUENCE MODELING VIA STATE SPACE MODEL (SSM)-ENHANCED TRANSFORMER, filed Dec. 14, 2022, the entirety of which is hereby incorporated herein by reference for all purposes.

### BACKGROUND

Transformers are machine learning models that encode a sequence of input tokens into an attention vector using a self-attention mechanism. Transformers may be configured for a variety of prediction tasks, including sequence to sequence or sequence-to-classification, for example. A sequence-to-sequence transformer includes a decoder that decodes the attention vector into an output sequence of tokens. Applications of sequence-to-sequence transformer models include language models that are configured to translate a sequence of words from a source language to a target language, and language models that predict a next word in a sequence of input words. Applications of sequence-to-classification models include sentiment analysis models that are configured to predict a sentiment (positive, neutral, negative, etc.) of a sequence of text, for example. The self-attention mechanism of transformers has been found to offer improved performance in such language and sentiment models over bidirectional recurrent neural networks, for example, due to the ability of the self-attention mechanism to attend to any other token in the input sequence evenly as compared to recurrent bidirectional neural networks in which attention between two tokens in a sequence would become attenuated as the distance the tokens increased.

One drawback of transformers of this type is that the computational complexity of computing self-attention in this manner is quadratic in terms of time and memory space based on the length of the input sequence, thereby imposing a practical limit on the length of the token sequence to be analyzed. Modern transformers limit the input sequence to 512 or 1024 tokens for example. Another issue with transformers that apply full self-attention is that transformers can easily overfit, making them susceptible to learning from noise. A class of transformers have been developed that limit the full attention mechanism using fast algorithms to linear complexity, however even these can suffer from overfitting due to a lack of structural bias. To address this, transformers with partial attention mechanisms such as sparse attention and clustering have been proposed, but these structural biases fail to capture truly global attention, instead being limited to the particular clustering or sparsity regime imposed.

State space models are a type of model that can capture global attention, but conventional state space models are largely based on recurrent neural networks, and these conventional recurrent neural networks state space models cannot compute dependency between any two input tokens in a sequence in an equally effective manner, as an attention-based transformer model does.

Accordingly, opportunities exist to improve the performance of attention-based models that make predictions based on long input sequences.

### SUMMARY

A computing device is provided including a processor configured to execute a transformer including an encoder having a global layer configured to receive tokenized embeddings for each of a plurality of tokens in a local input sequence and compute a global self-attention vector for each of the tokenized embeddings. The encoder further includes a local layer configured to receive each global self-attention vector from the global layer and compute local self-attention for each local input sequence, and add and normalize the global self-attention vector with the local self-attention vector to thereby produce an encoder representation including a self-attention vector for each local input sequence that includes both global self-attention values and local self-attention values. The transformer is configured to output a prediction for the global input sequence based on the encoder representation of each of the local input sequences of the global input sequence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates performance of a conventional transformer with full attention, a conventional transformer with window attention, and an S4 model.

FIG. 2 shows a computing system including a computing device configured to perform long sequence modeling via an SSM-enhanced transformer with a global layer including a state space model, according to one example of the present disclosure.

FIG. 3 illustrates details of a global layer of the decoder of the transformer of FIG. 2.

FIG. 4 illustrates window attention and chunk attention.

FIG. 5 illustrates experimental results on the Long Range Arena (LRA) dataset, comparing versions of the present transformer model with other conventional models.

FIG. 6 illustrates experimental results of three versions of the present transformer model with five other conventional models performing a benchmark test on the Wikitext-103 dataset.

FIG. 7 illustrates experimental results of two versions of the present transformer model with two other conventional models performing a benchmark test on the GLUE dev set.

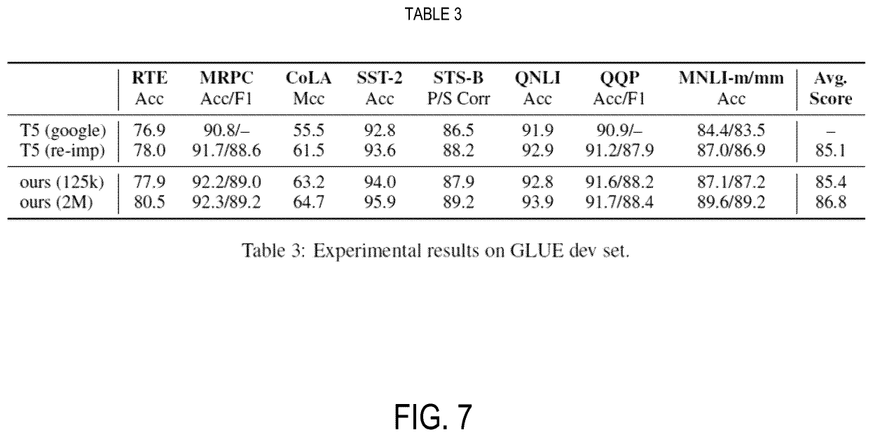

FIG. 8 illustrates a comparison of two versions of the present model with four conventional models, for memory usage and updates per second (computational complexity) for three different global sequence lengths.

FIG. 9 shows a flowchart of a computerized method according to one example implementation present disclosure.

FIG. 10 shows a schematic view of an example computing environment in which the computer device of FIG. 2 may be enacted.

### DETAILED DESCRIPTION

Transformer models have achieved superior performance in various natural language processing tasks. However, the quadratic computational cost of the attention mechanism limits its practicality for long sequences. Conventional attention variants sacrifice the ability of the transformer model to effectively compute global information in order to improve computational efficiency. On the other hand, state space models (SSMs) are tailored for long sequences, but SSMs are not flexible enough to capture complicated local information. To address the issues, an SSM-enhanced transformer model is provided. Specifically, an SSM is incorporated into an input layer of the encoder of a transformer model, and efficient local attention methods are employed for other layers. The SSM integrates global information, which complements the lack of long-range dependency issue in the local attention methods. Experimental results, discussed below, on the Long Range Arena benchmark and language modeling tasks demonstrate the effectiveness of the disclosed method. Moreover, the disclosed systems and methods are used to pre-train a sequence-to-sequence transformer model, fine-tuning results on natural language understanding and natural language generation tasks are presented.

### 1. Introduction

Transformer models have achieved superior performance on various natural language processing tasks such as language modeling, natural language generation and natural language understanding. These models leverage the attention mechanism, which computes a dependency score for every pair of tokens in an input sequence. Therefore, full attention has a quadratic time and space complexity with respect to the sequence length. However, such a complexity is computationally prohibitive for tasks that involve long sequences, such as text summarization and question answering. For example, it is found that one example a transformer model with 250M parameters consumes over 80 G of GPU memory when the sequence length is 8 k.

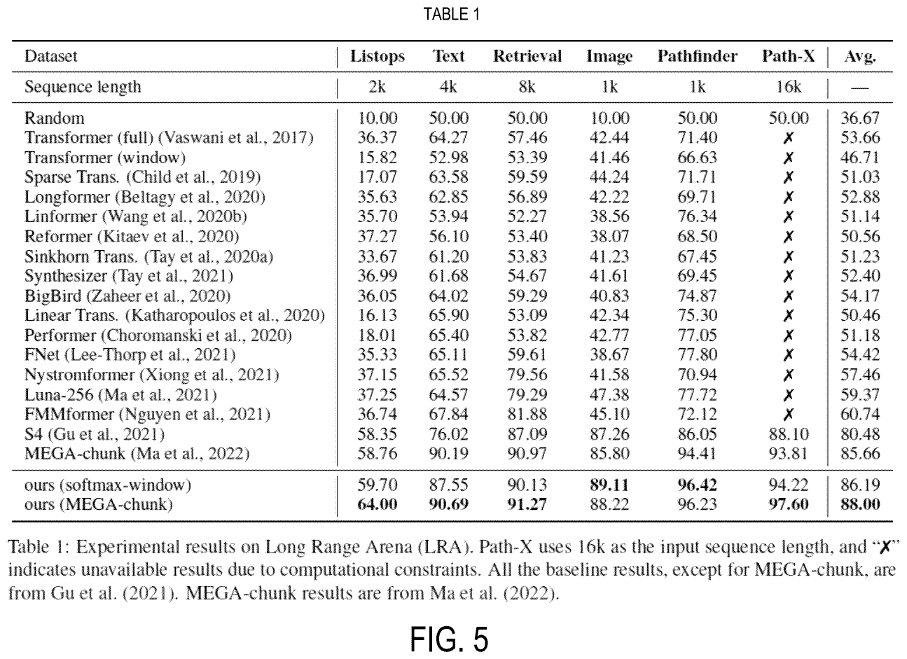

Additionally, transformer models equipped with full attention are easy to overfit because of the lack of structural biases. That is, the attention mechanism does not assume any structural prior over the inputs. For example, order information (e.g., through sinusoidal encoding) is needed to train the model. Therefore, full attention is too flexible such that transformer models may easily overfit to noise contained in the input sequence. This significantly limits the practicality of the models in long sequence modeling, where the dependency signal is often weak and the signal-to-noise ratio is often low. It has been found empirically that on a two-way classification task, an example transformer with a full attention mechanism has a 57.5% accuracy, nearly 30% less than state-of-the-art methods with powerful structural biases (see Table 1 of FIG. 5 for details).

Various approaches have been proposed to reduce the quadratic complexity discussed above and/or to introduce structural biases lacking in full attention mechanisms. For example, in approximation methods, full attention is approximated using fast algorithms with linear complexity. For example, the computation of the attention score matrix (i.e., softmax(QK^{T}/\sqrt{d}) in Eq. 1) may be approximated and accelerated using low-rank approximation or kernel methods. However, even though these methods reduce the complexity of full attention, these methods inherit the lack of structural bias issue.

To incorporate structural biases into a transformer model, partial attention methods have been proposed. Conventional partial attention methods can be categorized into sparse attention and clustering methods. In sparse attention, each token only attends to a subset of all the tokens according to pre-defined sparsity patterns. In clustering methods, tokens are divided into several clusters, and only intra-cluster attention is performed. However, the introduced structural biases from these approaches restrict the ability of the models to capture global information. For example, in local-window attention, it is assumed that each token only depends on its neighbors, such that long-range and global information is inevitably lost.

Contrary to partial attention, state space models (SSMs) introduce a different structural bias, which is tailored for computing global information. Specifically, SSMs design nearly fixes global dependency patterns, which facilitates effective and efficient computation. These models can be seen as linear recurrent neural networks with specifically designed, nearly fixed weights. Moreover, efficient linear time and space complexity algorithms have been crafted for training such models, in prior approaches. However, the integrated structural bias from these algorithms is still restrictive in that SSMs are not refined enough to capture local information. This is because unlike attention, SSMs do not explicitly compute dependency between input tokens.

To address these issues, a hierarchically-structured multi-layer transformer model that can effectively and efficiently capture complicated dependencies is proposed. Specifically, an SSM is incorporated into an input layer of a transformer decoder model, such that after this layer, inputs are integrated with global information. Because the SSM only provides coarse global information, at the subsequent top layers of the embodiment of the present disclosure, sparse attention variants are employed to capture more complicated and local information is refined. In other words, the SSM serves as a strong structural bias that integrates global information, and it complements the lack of long-range dependency issue in sparse attention methods.

As will be discussed in detail below, the efficiency and effectiveness of the disclosed systems and methods on various natural language processing tasks are demonstrated by test result data. First, it is shown that the proposed systems and methods outperform existing methods on the Long Range Arena benchmark, which is designed to test the ability of a model in modeling long sequences. Second, data is presented that shows that in autoregressive language modeling, the present systems and methods are not only significantly faster than conventional transformers, but also yield better performance. Third, data from language model pre-training and fine-tuning experiments is presented. Specifically, a sequence-to-sequence transformer model that has been pre-trained is fine-tuned on various tasks, including natural language understanding and natural language generation benchmarks. In all these settings, the present systems and methods outperform conventional pre-trained networks such as T5 and LongT5, which is a T5 variant tailored for long sequence modeling. Finally, data from analysis and ablation experiments is presented to further demonstrate the effectiveness of the disclosed systems and methods.

### 2 Preliminary Discussion

### 2.1 Attention Mechanism

Suppose input to a layer is X ∈ [symbol] ^{L×d}, where L is the sequence length and d is the embedding dimension. An attention mechanism can be defined that outputs:

$$Attn ( X ) = softmax ( \frac{{QK}^{T}}{\sqrt{d}} ) V , \qquad ( 1 )$$

$$where Q = {XW}_{q} , K = {XW}_{k} , V = {XW}_{v} .$$

Here W_{q}, Wₖ, Wᵥ ∈ [symbol] ^{d×d} are learnable weights. The attention mechanism can simultaneously compute the alignment between any pair of input tokens, such that it models long-range dependencies better than recurrent neural networks. Specifically, denoting the attention score matrix A=softmax (QK^{T}/\sqrt{d}) ∈ [symbol] ^{L×L}, then Aᵢⱼ captures the alignment between the i-th and the j-th input tokens.

### 2.2 State Space Models

Continuous time state space model. A continuous time latent space model maps a 1-dimensional input signal u(t) to a dₛ-dimensional latent state x(t), after which x(t) is mapped to a 1-dimensional output signal y(t). Concretely,

$${x}^{′} ( t ) = A x ( t ) + Bu ( t ) , y ( t ) = C x ( t ) . \qquad ( 2 )$$

Here, A ∈ [symbol] ^{d}^{ₛ}^{×d}^{ₛ}, B ∈ [symbol] ^{d}^{ₛ} and C ∈ [symbol] ^{d}^{ₛ}.

Eq. 2 can be leveraged to model long sequences. Since randomly initialized parameters A, B and C cannot model long-range dependencies well, a class of matrices (termed HiPPO, high-order polynomial projection operators) have been proposed to initialize A. The HIPPO matrices are designed such that the state x(t) can memorize the history of the input u(t) up to time t.

Discrete time state space model. In practice, discrete sequences such as natural language inputs (u₀, u₁, . . . , u_{L}), where L is the sequence length, are used, which cannot be easily modeled by a continuous time state space model. To facilitate modeling such discrete data, the model in Eq. 2 can be discretized (using the bilinear method) by a step size Δ, such that

$${x}_{k} = \overline{A} {x}_{k - 1} + \overline{B} {u}_{k} , {y}_{k} = \overline{C} {x}_{k} \qquad ( 3 )$$

$$where \overline{A} = {( I - Δ / 2 \cdot A )}^{- 1} ( I + Δ / 2 \cdot A ) ,$$

$$\overline{B} = {( I - Δ / 2 \cdot A )}^{- 1} Δ B , \overline{C} = C .$$

After the above recurrent representation is unrolled, it leads to:

$${y}_{k} = {\overline{CA}}^{k} \overline{B} {u}_{0} + … + \overline{CAB} {u}_{k - 1} + \overline{CB} {u}_{k} .$$

This can be written as a convolutional representation y=K̅*u, where the convolution kernel is represented as:

$$\overline{K} ∈ {ℝ}^{L} = ( \overline{CB} , \overline{C A B} , … , {\overline{C A}}^{L - 1} \overline{B} ) . \qquad ( 4 )$$

Here, “*” is the discrete convolution operator, u represents the input sequence (u₀, u₁, . . . , u_{L}), and y represents the corresponding output sequence (y₀, y₁, . . . , y_{L}).

In Eq. 4, the output y can be computed efficiently given that the convolution kernel K̅ is known. However, computing the kernel is non-trivial. Most of existing algorithms have O(L²) time and space complexity.

Structured State Space Sequence model (S4). The structured state space sequence model S4 has been developed to efficiently compute Eq. 4. Specifically, B and C in Eq. 2 are randomly initialized, and A is initialized as

$$A = {A}^{( {d}_{S} )} - P {P}^{T} , {B}_{i} = {( 2 i + 1 )}^{\frac{1}{2}} , \qquad ( 5 )$$

$$where {P}_{i} = {( i + 1 / 2 )}^{1 / 2} ,$$

$${A}_{i j}^{( {d}_{s} )} = - \{ \begin{matrix}{( i + \frac{1}{2} )}^{\frac{1}{2}} {( j + \frac{1}{2} )}^{\frac{1}{2}} , & i > j , \\ \frac{1}{2} , & i = j , \\ - {( i + \frac{1}{2} )}^{\frac{1}{2}} {( i + \frac{1}{2} )}^{\frac{1}{2}} , & i < j .\end{matrix}$$

Subsequently, the convolutional kernel in Eq. 4 can be computed efficiently with linear O(L) computational time and memory space complexity.

### 3 Method

First, data from simulations is presented to demonstrate that SSMs do not model local information well. Then, the systems and methods of the present disclosure are discussed, which efficiently and effectively combine global and local information by incorporating SSMs into the transformer architecture.

### 3.1 Attention vs. State Space Models

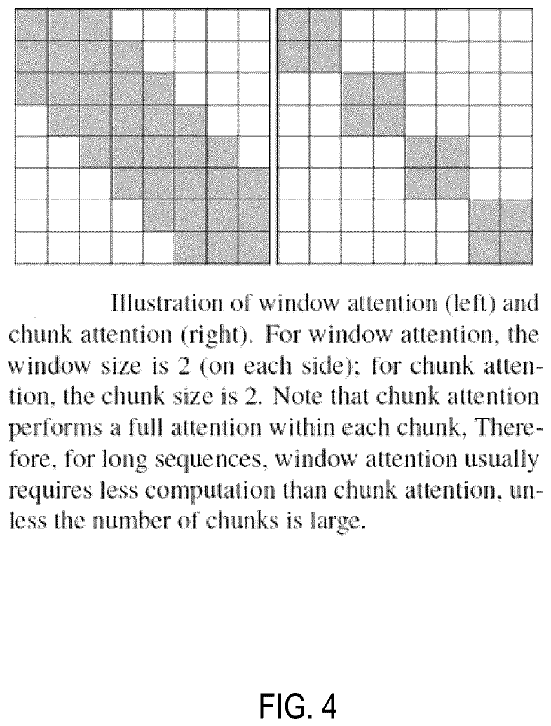

Now, an S4 model will be compared with an example transformer having a full attention mechanism, and a transformer configured with a window attention mechanism. In window attention, each token can only attend to its neighboring tokens within a fixed size window (see FIG. 4 for details). FIG. 4 illustrates window attention (left) and chunk attention (right). Simulation experiments were conducted on token-level language modeling. In this setting, local information is more important than global information. This is because in practice, it is rare to see words (tokens) that are thousands of positions apart exhibit strong dependency.

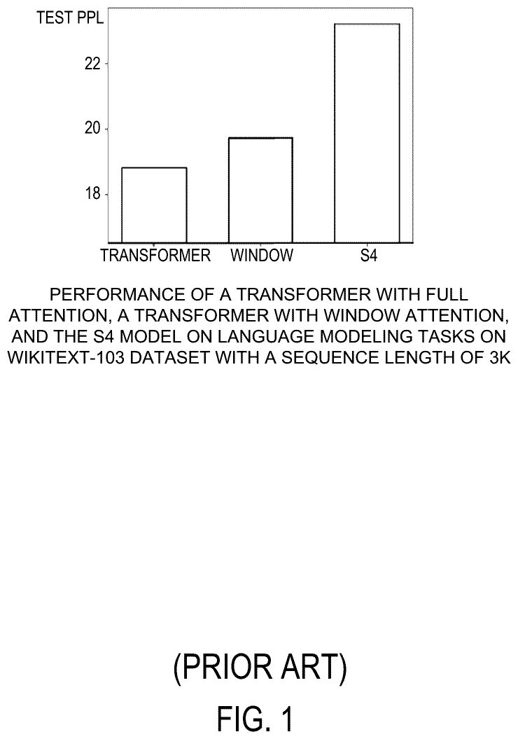

Experimental results are illustrated in FIG. 1. It is seen that a transformer with full and window attention outperform the S4 model. Notice that replacing full attention with window attention does not significantly hurt model performance, indicating that local information is more important in this setting. State space models such as the S4 model produce a nearly fixed dependency pattern, e.g., the convolution kernel in Eq. 4. Moreover, unlike a conventional self-attention mechanism, SSMs do not directly compute dependency between tokens. Therefore, SSMs are not refined enough to capture local information, such that they perform poorly on language modeling tasks.

### 3.2 SSM-Enhanced Transformer

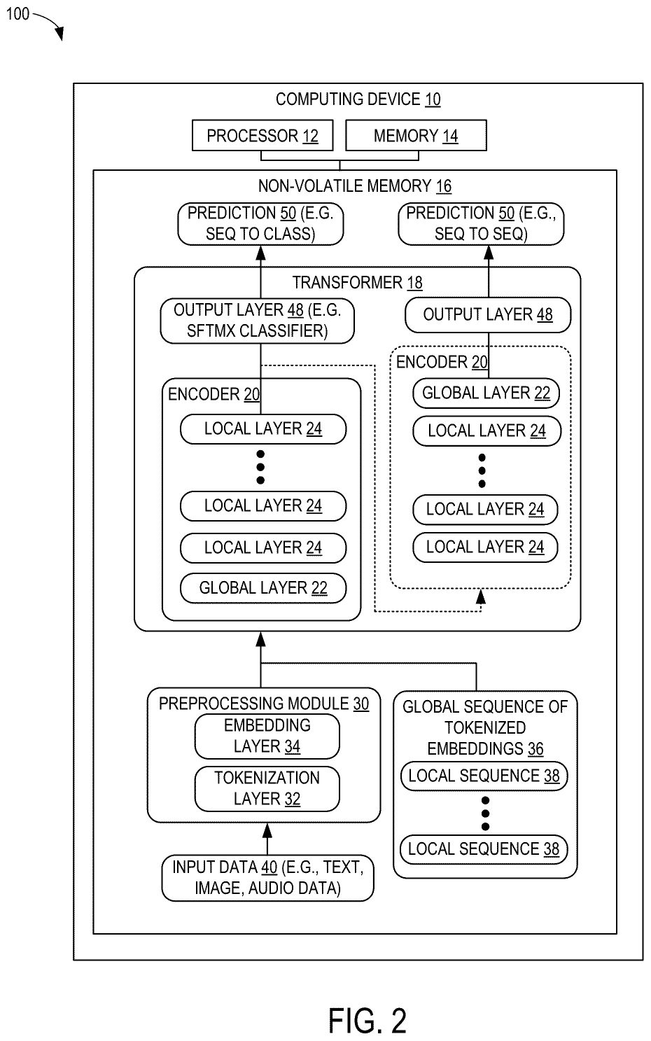

Systems and methods according to the present disclosure will now be described, which utilize a multi-layer transformer model that can capture complicated global and local information. The overall architecture is shown in FIG. 2. The proposed model employs a hierarchical structure. Specifically, at the bottom layer of the present model (termed the global layer), global dependency is captured using an SSM. Because the SSM only provides coarse global information, the subsequent local layers facilitate the model to handle more refined and complicated local dependencies. In other words, the SSM serves as a strong structural bias that integrates global information to the inputs.

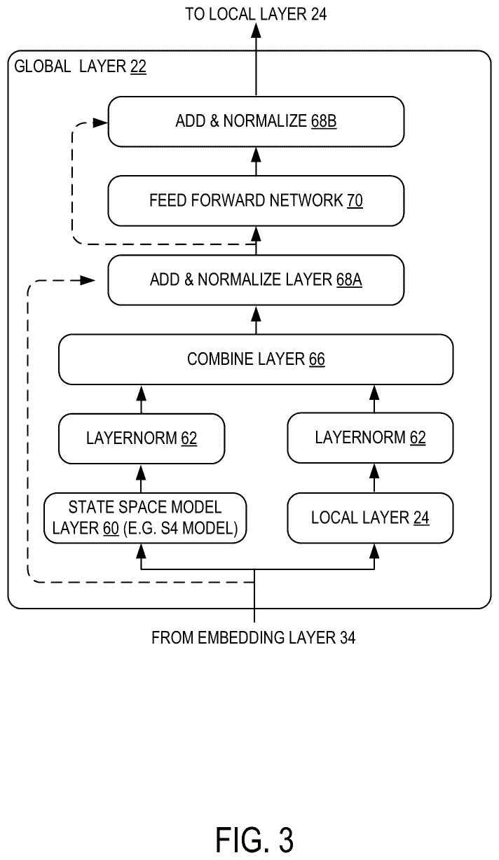

To instantiate the local layer, the full attention in the conventional Transformer layer is replaced with off-the-shelf efficient sparse attention methods. The present systems and methods are flexible enough to accommodate different methods, such as window attention and chunk attention. See FIG. 3 for illustration of the portions of a global sequence to which window and chunk attention are directed, shown in grey).

In the global layer (FIG. 3), given the input X to the layer, the output Y is computed as

$${X}_{local} = Local ( LN ( X ) ) ,$$

$${X}_{global} = SSM ( LN ( X ) ) ,$$

$${X}_{a} = W [ LN ( {X}_{local} ) , LN ( {X}_{global} ) ] + X ,$$

$$Y = FFN ( LN ( {X}_{a} ) ) + {X}_{a} .$$

Here, LN(·) denotes layer normalization (Ba et al., 2016), FFN(·) denotes a two-layer feed-forward neural network, and W is a trainable weight that combines local and global representations. Notice that layer normalization is applied to X_{local} and X_{global} to align their scales. In this work, S4 is chosen as the state space model.

In FIG. 2 a computing system 100 including a computing device 10 configured to perform long sequence modeling via an SSM-enhanced transformer with a global layer 22 including a state space model is shown, which comprises a processor 12 and associated working memory 14 (e.g., RAM) and non-volatile memory 16 (e.g., solid state drive (SSD)), including stored instructions that when executed by the processor 12 cause the processor 12 to implement software to achieve the functions described herein. The processor 12 is configured to execute a preprocessing module 30 including a tokenization layer 32 and an embedding layer 34. The tokenization layer 32 tokenizes input data 40 into a global sequence of tokens. The input data 40 may be text data, image data (including still image or video data), audio data, or other data, for example. The processor 12 is further configured to execute a transformer 18 including an encoder 20. The encoder 20 has a global layer 22 and at least one or a plurality of local layers 24. While three local layers 24 are shown in the depicted configuration, it will be appreciated that this is merely exemplary. In one example, 15 local layers 24 are provided.

It will be appreciated that the input data can contain text or other type of sequenced data, which is tokenized by the tokenization layer into a global input sequence of tokens. Embeddings are generated by the embedding layer 34 for the tokens, to thereby generate a global input sequence of tokenized embeddings. The global input sequence of tokenized embeddings is in turn broken up into a plurality of local input sequences by the preprocessing module and passed to a global layer 22 of the encoder of the transformer 18. The global layer 22 is configured to, for each of a plurality of local input sequences in a global input sequence, receive tokenized embeddings for each of a plurality of tokens in the local input sequence, from the embedding layer 34, and compute a global self-attention vector for each of the tokenized embeddings in the local input sequence.

The encoder of the transformer 18 further includes a local layer 24 configured to receive the global self-attention vector for each local input sequence from the global layer 22 and compute local self-attention for the local input sequence, and add and normalize the global self-attention vector with the local self-attention vector to thereby produce an encoder representation including a self-attention vector for each local input sequence that includes both global self-attention values and local self-attention values. The transformer 18 is configured to output a prediction 50 for the global input sequence according to a prediction task based on the encoder representation of each of the local input sequences of the global input sequence.

The transformer 18 can also include a classification layer configured to receive the encoder representation and generate the prediction 50, the prediction 50 including one or a plurality of predicted classifications. In such a configuration, the transformer 18 is configured as a sequence to classification transformer model, and example of which is a sentiment analysis model, for text input. Alternatively, the transformer 18 can be a sequence-to-sequence transformer that includes a decoder including one or a plurality of local layers 24 and a global layer 22. In such a configuration, the decoder is configured to decode receive the encoder representation and generate as the prediction an output sequence of tokens based upon the plurality of local input sequences in the global input sequence.

FIG. 3 shows the details of the architecture and data flow in the global layer 22 of the encoder of FIG. 1. As shown in FIG. 3, the global layer 22 includes a state space model layer 60 configured to receive the tokenized embeddings for each of the plurality of tokens in the local input sequence, from the embedding layer 34. The state space model layer 60 can include a discrete time structured state space sequence model parameterized by normal plus low rank matrices. One example of such a model is the S4 model. Using such a model, computation of the global self-attention using the global layer 22 including the state space model layer 60 can be accomplished with linear computational complexity and linear memory complexity relative to the global input sequence.

Continuing with FIG. 3, the global layer 22 further includes a local layer 24 positioned in a parallel data path to the state space model layer 60. The local layer 24 is configured to receive the tokenized embeddings for each of the plurality of tokens in the local input sequence, from the embedding layer 34 and compute local self-attention for the local input sequence. After each of the SSM layer and the local layer 24, respective normalization layers are provided, to normalize the values in the respectively computed attention vectors in each data flow path.

As shown in FIG. 3, the global layer 22 further includes a combine layer 66 configured to concatenate the global self-attention and the local self-attention computed within the global layer 22. The global layer 22 further includes an add and normalize layer 68A configured to add and normalize the concatenated global self-attention and local self-attention computed within the global layer 22 with the tokenized embeddings output from the embedding layer 34. Finally, the global layer 22 further includes a feed forward network 70 that is configured to receive the normalized, combined global and self-attention vectors computed in the global layer 22 and output a predicted global layer output at inference time. Another add and normalize layer 68B is typically positioned after the feed forward network, as shown.

### 4 Experimental Results

In the following described experiments, all of the models were implemented using PyTorch, Fairseq, and HuggingFace.

### 4.1 Long Range Arena

Dataset. The effectiveness of the proposed model on Long Range Arena, which is a benchmark tailored for evaluating the ability of models in modeling long sequences, are evaluated. The benchmark contains six tasks: ListOps, which tests the capability of modeling hierarchically structured data; byte-level text classification on the IMDB movie review dataset; byte-level document retrieval on the ACL anthology network; pixel-level image classification on CIFAR-10; Pathfinder, which tests the capability in modeling spatial dependency; and a longer version of Pathfinder, Path-X.

Models. Following the standard setting, small models (e.g., less than 2M parameters) are used for all tasks in these experiments. The computational budget is limited such that all the models are trained with similar speed for the same amount of time.

To aggregate local information, two approaches were considered: window attention and chunk attention. For window attention, the conventional softmax attention is sparsified; and for chunk attention, MEGA, which employs a gated attention technique, is sparsified. For window attention, the window size was set to 128, except for in Path-X, where the window size was set to 1024. For chunk attention, the chunk size was set to 128, except for Path-X, where the chunk size was set to 4096.

Results. Experimental results are summarized in Table 1. It is seen that both variants of the present model (softmax-window and MEGA-chunk) constructed according to the system shown in FIGS. 2 and 3 significantly outperform all the baselines in terms of average accuracy. For example, the window attention variant outperforms the best-performing baseline (MEGA-chunk) by 0.5%, and the chunk attention variant has a 2.4% performance gain. Therefore, the present approach is more suitable to model long sequences than conventional approaches.

### 4.2 Language Modeling

The present model is further evaluated by conducting language modeling experiments on the Wikitext-103 dataset. This dataset contains English-language Wikipedia articles, and the total number of training tokens is 103M. In all the experiments, a large-scale transformer model with 16 layers and around 250M parameters is used. The input sequence length is set to 3 k and trained for a total 286 k steps. Similar to the Long Range Arena (LRA) experiments, the present model was equipped with either window attention (softmax-window) or chunk attention (MEGA-chunk) as the local information extractor. Additionally, another variant, FLASH-chunk, was evaluated, where FLASH is a gated attention method similar to MEGA, and is sparsified.

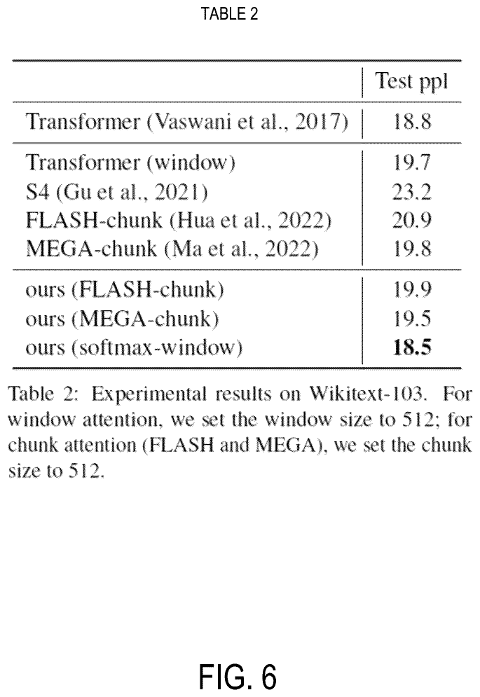

Experimental results are presented in Table 2, reproduced in FIG. 6. From the results, it is seen that by combining global and local information, the proposed model achieves significant performance improvement and outperform other baselines. For example, conventional window attention has a 19.7 perplexity on the test set, and by integrating an SSM into the present model, a 1.2 perplexity gain is achieved. The present model (with softmax-window) is not only significantly faster than a transformer with full attention, but also yields a better performance.

### 4.3 Large Language Model Pretraining

It will be appreciated that the present model can be applied to large language model pretraining. For example, the pre-training may be of a large language model on Wikipedia dataset and on the BookCorpus data set, or on both of these plus the common crawl news dataset CC-News. These are extremely large datasets and pretraining a transformer language on such datasets can often take weeks of GPU time, thus speedups in computational complexity and lower memory requirements of the present model will have an appreciable savings in time and cost of such pretraining.

### 5. Memory Usage and Updates per Second

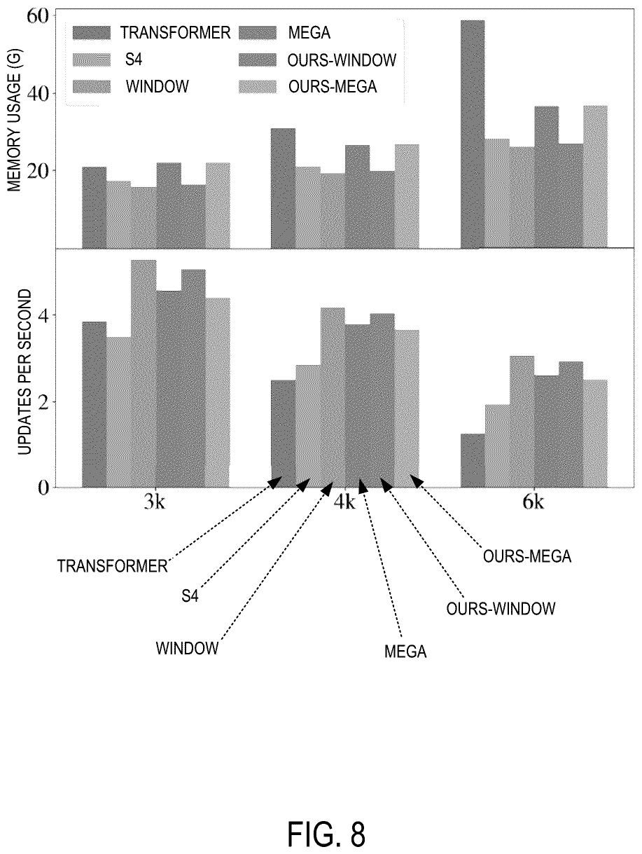

FIG. 8 illustrates memory usage and updates per second for the present transformer using a window attention approach and the MEGA approach discussed above, as compared to conventional transformers, for different global sequence lengths of 3K, 4K and 6K. As can be seen, particularly on the longest sequence, the present model with either window or MEGA configuration achieves among the highest updates per second (evidence of lowest computational complexity/cost) while using among the lowest amount of memory.

### 6 Appendix

### 6.1 Efficient Transformer Models

In Eq. 1, Q, K, V ∈ [symbol] ^{L×d} is provided, such that computing the attention Attn(X) introduces O(L²) time and space costs. Such quadratic costs are prohibitive when the sequence length L is large. There are various attempts to reduce the quadratic time and space complexity of the conventional full self-attention.

One approach is to employ sparse attention. That is, each token only attends to a subset of all the tokens according to pre-defined patterns, e.g., neighboring tokens within a fixed size window. Some examples include Sparse Transformer, BlockBERT, Longformer, ETC, BigBird, HEPOS, and Poolingformer.

Another approach is to use low-rank projection. For example, in Linformer, the attention mechanism in Eq. 1 becomes Attn(X)=softmax(Q(EK)^{T}/\sqrt{d})(FV). Here, the two additional parameters satisfy E, F ∈ [symbol] ^{r×L}, where r is the projection rank such that r<<L. Simi-lar methods include Nyströmformer, Synthesizer, Transformer-LS, and Luna. However, these approaches face difficulty when handling causal tasks, such as auto-regressive language modeling. Specifically, in Eq. 1, the upper triangular part is masked out in the attention score matrix A ∈ [symbol] ^{L×L} such that each token can only attend to its previous tokens. However, this is implausible in Linformer since the L×L matrix to a L×r matrix is projected.

Kernel-based approaches can be used to approximate the full attention Attn(X). In these approaches, the quadratic-time softmax attention is replaced by fast linear-time kernel approximations (e.g., Gaussian and arccosine kernel). Some examples include Linear Transformer, Performer, Random Feature Attention, and FMMformer. Both low-rank projection and kernel-based approaches approximate the full attention, and thus, the approaches often suffer from non-negligible approximation error.

Clustering-based approaches may be adopted, where Q or K is divided into several clusters, and only inter-cluster attention is performed. Such methods include Reformer, Cluster-former, Sinkhorn Transformer, Fast Transformer, Routing Transformer, and FLASH.

### 6.2 Pre-trained Language Models

Pre-trained language models have achieved state-of-the-art performance on various natural language processing tasks. However, most of these models are not suitable for long sequences. For example, BERT uses a fixed-length positional embedding, such that it cannot handle sequences with length more than 512. In contrast, LongT5 facilitates training on long sequences by leveraging relative positional embedding and local-window attention. The model targets long sequence modeling tasks such as text summarization and question answering.

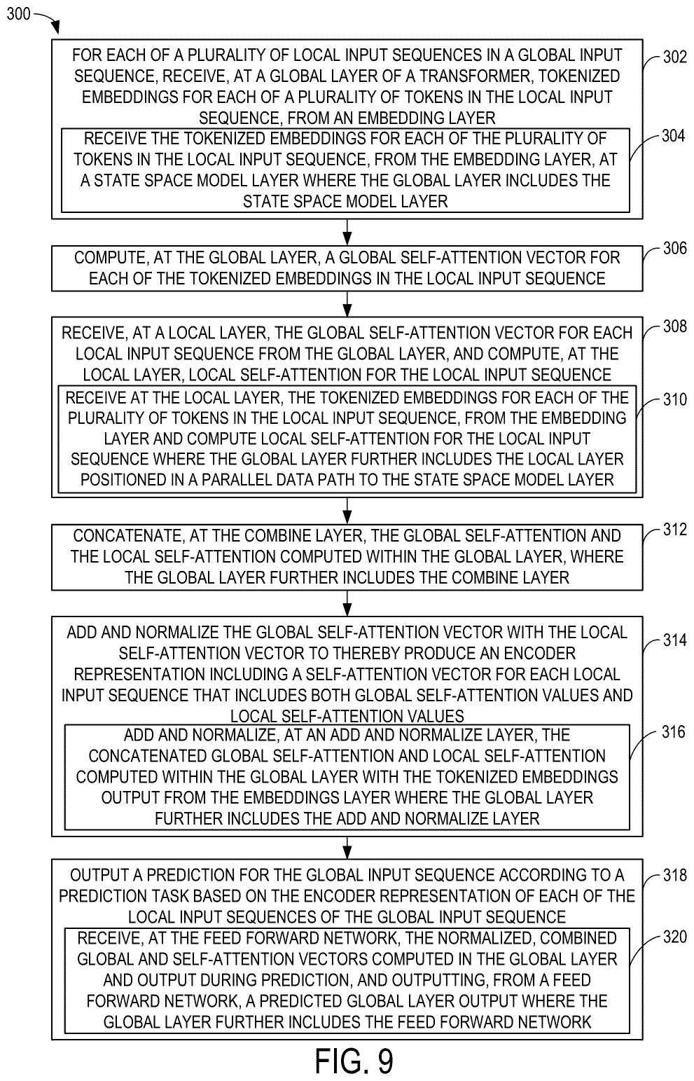

FIG. 9 shows a flowchart of a computerized method 300 according to one example implementation present disclosure. At step 302, the method may include, for each of a plurality of local input sequences in a global input sequence, receiving, at a global layer of a transformer, tokenized embeddings for each of a plurality of tokens in the local input sequence, from an embedding layer. At step 304, the method may further include receiving the tokenized embeddings for each of the plurality of tokens in the local input sequence, from the embedding layer, at a state space model layer where the global layer includes the state space model layer. At step 306, the method may include computing, at the global layer, a global self-attention vector for each of the tokenized embeddings in the local input sequence. At step 308, the method may include receiving, at a local layer, the global self-attention vector for each local input sequence from the global layer, and computing, at the local layer, local self-attention for the local input sequence. At step 310, the method may further include receiving, at the local layer, the tokenized embeddings for each of the plurality of tokens in the local input sequence, from the embedding layer and computing local self-attention for the local input sequence where the global layer further includes the local layer positioned in a parallel data path to the state space model layer. At step 312, the method may include concatenating, at a combine layer, the global self-attention and the local self-attention computed within the global layer where the global layer further includes the combine layer.

At step 314, the method may include adding and normalizing the global self-attention vector with the local self-attention vector to thereby produce an encoder representation including a self-attention vector for each local input sequence that includes both global self-attention values and local self-attention values. At step 316, the method may further include adding and normalizing, at an add and normalize layer, the concatenated global self-attention and local self-attention computed within the global layer with the tokenized embeddings output from the embeddings layer, where the global layer further includes the add and normalize layer. At step 318, the method may include outputting a prediction for the global input sequence according to a prediction task based on the encoder representation of each of the local input sequences of the global input sequence. At step 320, the method may further include receiving, at the feed forward network, the normalized, combined global and self-attention vectors computed in the global layer and output during prediction, and outputting, from a feed forward network, a predicted global layer output, where the global layer further includes the feed forward network.

As the experimental results demonstrate, it will be appreciated that the above-described systems and methods have the potential technical benefit of offering performance advantages in terms of lower computational complexity and memory requirements as well as higher accuracy of prediction on certain prediction tasks involving long sequences of input data than the above discussed approaches.

### 7. Computational Environment

In some embodiments, the methods and processes described herein may be tied to a computing system of one or more computing devices. In particular, such methods and processes may be implemented as a computer-application program or service, an application-programming interface (API), a library, and/or other computer-program product.

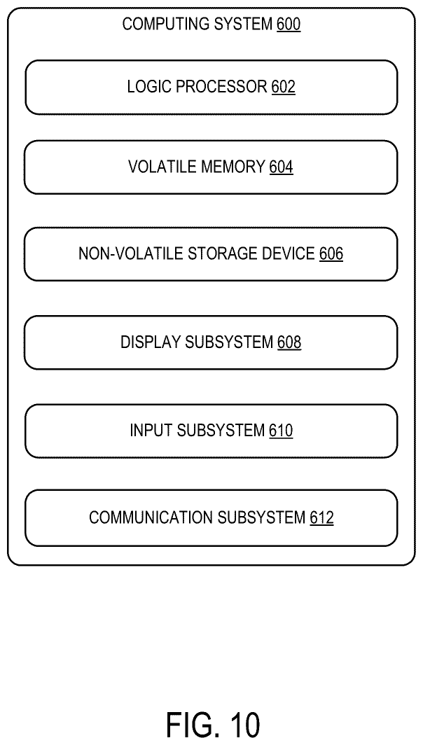

FIG. 10 schematically shows a non-limiting embodiment of a computing system 600 that can enact one or more of the methods and processes described above. Computing system 600 is shown in simplified form. Computing system 600 may embody the computer device 10 described above and illustrated in FIG. 2. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 10.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory (e.g., CD, DVD, HD-DVD, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

The following paragraphs provide additional support for the claims of the subject application. One aspect provides a computing device. The computing device may include a transformer including an encoder having a global layer and a local layer. The global layer may be configured to, for each of a plurality of local input sequences in a global input sequence, receive tokenized embeddings for each of a plurality of tokens in the local input sequence, from an embedding layer. The global layer may be further configured to compute a global self-attention vector for each of the tokenized embeddings in the local input sequence. The local layer may be configured to receive the global self-attention vector for each local input sequence from the global layer and compute local self-attention for the local input sequence. The local layer may be further configured to add and normalize the global self-attention vector with the local self-attention vector to thereby produce an encoder representation including a self-attention vector for each local input sequence that includes both global self-attention values and local self-attention values. The transformer may be configured to output a prediction for the global input sequence according to a prediction task based on the encoder representation of each of the local input sequences of the global input sequence.

According to this aspect, the global layer may include a state space model layer configured to receive the tokenized embeddings for each of the plurality of tokens in the local input sequence, from the embedding layer.

According to this aspect, the state space model layer may include a discrete time structured state space sequence model parameterized by normal plus low rank matrices.

According to this aspect, the discrete time structured state space sequence model may be an S4 model.

According to this aspect, computation of the global self-attention using the global layer including the state space model layer may be accomplished with linear computational complexity and linear memory complexity relative to the global input sequence.

According to this aspect, the global layer may further include a local layer positioned in a parallel data path to the state space model layer.

According to this aspect, the local layer may be configured to receive the tokenized embeddings for each of the plurality of tokens in the local input sequence, from the embedding layer and compute local self-attention for the local input sequence.

According to this aspect, the global layer may further include a combine layer configured to concatenate the global self-attention and the local self-attention computed within the global layer.

According to this aspect, the global layer may further include an add and normalize layer configured to add and normalize the concatenated global self-attention and local self-attention computed within the global layer with the tokenized embeddings output from the embeddings layer.

According to this aspect, the global layer may further include a feed forward network that is configured to receive the normalized, combined global and self-attention vectors computed in the global layer and output a predicted global layer output at inference time.

According to this aspect, the transformer may include a classification layer configured to receive the encoder representation and generate the prediction, the prediction including one or a plurality of predicted classifications.

According to this aspect, the transformer may be a sequence-to-sequence transformer that includes a decoder including a local layer and a global layer, the decoder being configured to decode receive the encoder representation and generate as the prediction an output sequence of tokens based upon the plurality of local input sequences in the global input sequence.

According to another aspect of the present disclosure, a computerized method is provided. According to this aspect, the computerized method may include, for each of a plurality of local input sequences in a global input sequence, receiving, at a global layer of a transformer, tokenized embeddings for each of a plurality of tokens in the local input sequence, from an embedding layer. The computerized method may further include computing, at the global layer, a global self-attention vector for each of the tokenized embeddings in the local input sequence. The computerized method may further include receiving, at a local layer, the global self-attention vector for each local input sequence from the global layer. The computerized method may further include computing, at the local layer, local self-attention for the local input sequence. The computerized method may further include adding and normalizing the global self-attention vector with the local self-attention vector to thereby produce an encoder representation including a self-attention vector for each local input sequence that includes both global self-attention values and local self-attention values. The computerized method may further include outputting a prediction for the global input sequence according to a prediction task based on the encoder representation of each of the local input sequences of the global input sequence.

According to this aspect, the global layer may include a state space model layer, and the computerized method may further include receiving the tokenized embeddings for each of the plurality of tokens in the local input sequence, from the embedding layer, at the state space model layer.

According to this aspect, the state space model layer may include a discrete time structured state space sequence model parameterized by normal plus low rank matrices.

According to this aspect, the global layer may further include a local layer positioned in a parallel data path to the state space model layer, and the method may further include receiving, at the local layer, the tokenized embeddings for each of the plurality of tokens in the local input sequence, from the embedding layer and computing local self-attention for the local input sequence.

According to this aspect, the global layer may further include a combine layer, and the method may further include concatenating, at the combine layer, the global self-attention and the local self-attention computed within the global layer.

According to this aspect, the global layer may further include an add and normalize layer, and the method may further include adding and normalizing, at the add and normalize layer, the concatenated global self-attention and local self-attention computed within the global layer with the tokenized embeddings output from the embeddings layer.

According to this aspect, the global layer may further include a feed forward network, and the method may further include receiving, at the feed forward network, the normalized, combined global and self-attention vectors computed in the global layer and output during prediction, and outputting, from the feed forward network, a predicted global layer output.

According to another aspect of the present disclosure, a computer device is provided. The computing device may include a transformer including an encoder having a global layer and a local layer. The global layer may be configured to, for each of a plurality of local input sequences in a global input sequence, receive tokenized embeddings for each of a plurality of tokens in the local input sequence, from an embedding layer. The global layer may be further configured to compute a global self-attention vector for each of the tokenized embeddings in the local input sequence. The local layer may be configured to receive the global self-attention vector for each local input sequence from the global layer and compute local self-attention for the local input sequence. The local layer may be further configured to add and normalize the global self-attention vector with the local self-attention vector to thereby produce an encoder representation including a self-attention vector for each local input sequence that includes both global self-attention values and local self-attention values. The transformer may be configured to output a prediction for the global input sequence according to a prediction task based on the encoder representation of each of the local input sequences of the global input sequence. The global layer may include a state space model layer configured to receive the tokenized embeddings for each of the plurality of tokens in the local input sequence, from the embedding layer. The state space model layer may include a discrete time structured state space sequence model parameterized by normal plus low rank matrices. Computation of the global self-attention using the global layer including the state space model layer may be accomplished with linear computational complexity and linear memory complexity relative to the global input sequence.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a transformer including an encoder having
a global layer configured to:
for each of a plurality of local input sequences in a global input sequence, receive tokenized embeddings for each of a plurality of tokens in the local input sequence, from an embedding layer;
compute a global self-attention vector for each of the tokenized embeddings in the local input sequence;
a local layer configured to receive the global self-attention vector for each local input sequence from the global layer and compute local self-attention for the local input sequence; and
add and normalize the global self-attention vector with the local self-attention vector to thereby produce an encoder representation including a self-attention vector for each local input sequence that includes both global self-attention values and local self-attention values, wherein
the transformer is configured to output a prediction for the global input sequence according to a prediction task based on the encoder representation of each of the local input sequences of the global input sequence.

2. The computing device of claim 1, wherein the global layer includes a state space model layer configured to receive the tokenized embeddings for each of the plurality of tokens in the local input sequence, from the embedding layer.

3. The computing device of claim 2, wherein the state space model layer includes a discrete time structured state space sequence model parameterized by normal plus low rank matrices.

4. The computing device of claim 3, wherein the discrete time structured state space sequence model is an S4 model.

5. The computing device of claim 2, wherein computation of the global self-attention using the global layer including the state space model layer is accomplished with linear computational complexity and linear memory complexity relative to the global input sequence.

6. The computing device of claim 2, wherein the global layer further includes a local layer positioned in a parallel data path to the state space model layer.

7. The computing device of claim 6, wherein the local layer is configured to receive the tokenized embeddings for each of the plurality of tokens in the local input sequence, from the embedding layer and compute local self-attention for the local input sequence.

8. The computing device of claim 7, wherein the global layer further includes a combine layer configured to concatenate the global self-attention and the local self-attention computed within the global layer.

9. The computing device of claim 8, wherein the global layer further includes an add and normalize layer configured to add and normalize the concatenated global self-attention and local self-attention computed within the global layer with the tokenized embeddings output from the embeddings layer.

10. The computing device of claim 9, wherein the global layer further includes a feed forward network that is configured to receive the normalized, combined global and self-attention vectors computed in the global layer and output a predicted global layer output at inference time.

11. The computing device of claim 10, wherein the transformer includes a classification layer configured to receive the encoder representation and generate the prediction, the prediction including one or a plurality of predicted classifications.

12. The computing device of claim 10, wherein the transformer is a sequence-to-sequence transformer that includes a decoder including a local layer and a global layer, the decoder being configured to decode receive the encoder representation and generate as the prediction an output sequence of tokens based upon the plurality of local input sequences in the global input sequence.

13. A computerized method, comprising:
for each of a plurality of local input sequences in a global input sequence, receiving, at a global layer of a transformer, tokenized embeddings for each of a plurality of tokens in the local input sequence, from an embedding layer;
computing, at the global layer, a global self-attention vector for each of the tokenized embeddings in the local input sequence;
receiving, at a local layer, the global self-attention vector for each local input sequence from the global layer;
computing, at the local layer, local self-attention for the local input sequence;
adding and normalizing the global self-attention vector with the local self-attention vector to thereby produce an encoder representation including a self-attention vector for each local input sequence that includes both global self-attention values and local self-attention values; and
outputting a prediction for the global input sequence according to a prediction task based on the encoder representation of each of the local input sequences of the global input sequence.

14. The computerized method of claim 13, wherein the global layer includes a state space model layer, the method further comprising:
receiving the tokenized embeddings for each of the plurality of tokens in the local input sequence, from the embedding layer, at the state space model layer.

15. The computerized method of claim 14, wherein the state space model layer includes a discrete time structured state space sequence model parameterized by normal plus low rank matrices.

16. The computerized method of claim 14, wherein the global layer further includes a local layer positioned in a parallel data path to the state space model layer, the method further comprising:
receiving, at the local layer, the tokenized embeddings for each of the plurality of tokens in the local input sequence, from the embedding layer and computing local self-attention for the local input sequence.

17. The computerized method of claim 16, wherein the global layer further includes a combine layer, the method further comprising:
concatenating, at the combine layer, the global self-attention and the local self-attention computed within the global layer.

18. The computerized method of claim 17, wherein the global layer further includes an add and normalize layer, the method further comprising,
adding and normalizing, at the add and normalize layer, the concatenated global self-attention and local self-attention computed within the global layer with the tokenized embeddings output from the embeddings layer.

19. The computerized method of claim 18, wherein the global layer further includes a feed forward network, the method further comprising:
receiving, at the feed forward network, the normalized, combined global and self-attention vectors computed in the global layer and output during prediction, and outputting, from the feed forward network, a predicted global layer output.

20. A computing device, comprising:
a transformer including an encoder having
a global layer configured to:
for each of a plurality of local input sequences in a global input sequence, receive tokenized embeddings for each of a plurality of tokens in the local input sequence, from an embedding layer;
compute a global self-attention vector for each of the tokenized embeddings in the local input sequence;
a local layer configured to
receive the global self-attention vector for each local input sequence from the global layer and compute local self-attention for the local input sequence; and
add and normalize the global self-attention vector with the local self-attention vector to thereby produce an encoder representation including a self-attention vector for each local input sequence that includes both global self-attention values and local self-attention values, wherein
the transformer is configured to output a prediction for the global input sequence according to a prediction task based on the encoder representation of each of the local input sequences of the global input sequence,
the global layer includes a state space model layer configured to receive the tokenized embeddings for each of the plurality of tokens in the local input sequence, from the embedding layer,
the state space model layer includes a discrete time structured state space sequence model parameterized by normal plus low rank matrices, and
computation of the global self-attention using the global layer including the state space model layer is accomplished with linear computational complexity and linear memory complexity relative to the global input sequence.
